(19) United States
(12) Patent Application Publication
(10) Pub. No.: US 2020/0326028 A1
(43) Pub. Date: Oct. 15, 2020

(54) THERMALLY-INSULATED MODULES AND RELATED METHODS

(71) Applicant: CONCEPT GROUP LLC, Wellesley, MA (US)

(72) Inventors: Shriram RADHAKRISHNAN, West Palm Beach, FL (US); David H. REID, Jr., Fort Pierce, FL (US); Aarne H. REID, Jupiter, FL (US)

(21) Appl. No.: 16/761,972

(22) PCT Filed: Nov. 6, 2018
(86) PCT No.: PCT/US2018/059478

§ 371 Date: May 6, 2020

Related U.S. Application Data
(60) Provisional application No. 62/581,966, filed on Nov. 6, 2017.
(60) Provisional application No. 62/658,022, filed on Apr. 16, 2018.

(51) Int. Cl. F16L 59/065; A47J 41/02

(52) U.S. Cl. CPC F16L 59/065; F17C 3/02; F17C 2203/0395; A47J 41/02

(57) ABSTRACT

Provided are thermally insulated modules that comprise a first shell and a first component having a first sealed evacuated insulating space therebetween and a current carrier configured to give rise to inductive heating. Also provided are methods of utilizing the disclosed thermally insulated modules in a variety of applications, including additive manufacturing and other applications.

### RELATED APPLICATIONS

The present application claims priority to and the benefit of U.S. Patent Application No. 62/581,966, “Vacuum Insulated Structures Comprising Ceramic Materials” (filed Nov. 6, 2017) and U.S. Patent Application No. 62/658,022, “Thermally-Insulted Modules And Related Methods” (filed Apr. 16, 2018), both of which applications are incorporated herein by reference in their entireties for any and all purposes.

### TECHNICAL FIELD

The present disclosure relates to the field of thermal insulation components.

### BACKGROUND

In many applications—including, e.g., additive manufacturing—there is a need to heat a working material while minimizing excess heat emitted to the environment exterior to the working material. In other applications, there is a need to heat a working material while the module used to heat the working material maintains a relatively cool exterior. Accordingly, there is a long-felt need in the art for thermally-insulated modules that allow for heating of working material while maintaining some degree of thermal insulation of the heated working material.

### SUMMARY

In meeting the described long-felt needs, the present disclosure provides insulated modules that are suitable for use in a variety of applications, including such high-performance applications as additive manufacturing and materials processing. The disclosed modules allow for, inter alia, controllable heating of a working material while also thermally insulating that working material.

In one aspect, the present disclosure provides insulating modules, comprising: a nonconducting first shell; a conducting first component, the first shell being disposed about the first component, the first shell comprising a sealed evacuated insulating space, (b) the first shell and first component having a first sealed evacuated insulating space therebetween, the first component comprising a sealed evacuated insulating space, or any one or more of (a), (b), and (c); and a current carrier configured to give rise to inductive heating.

Also provided are insulating modules, comprising: a conducting first shell; a non-conducting first component, the first shell being disposed about the first component, the first shell comprising a sealed evacuated insulating space, (b) the first shell and first component having a first sealed evacuated insulating space therebetween, the first component comprising a sealed evacuated insulating space, or any one or more of (a), (b), and (c); and a current carrier configured to give rise to inductive heating.

Further provided are insulating modules, comprising: a non-conducting first shell; a non-conducting first component, the first shell being disposed about the first component, the first shell comprising a sealed evacuated insulating space, (b) the first shell and first component having a first sealed evacuated insulating space therebetween, the first component comprising a sealed evacuated insulating space, or any one or more of (a), (b), and (c); and a current carrier configured to give rise to inductive heating.

Further provided are methods, comprising: operating the current carrier of an insulating module according to the present disclosure so as to increase, by inductive heating, the temperature of a working material disposed within the inner shell of the insulating module.

Additionally provided are insulating modules, comprising: a first shell that comprises a material susceptible to inductive heating, the first shell having a first sealed evacuated insulating space therein; and a current carrier configured to give rise to inductive heating of the material susceptible to inductive heating.

Further disclosed are insulating modules, comprising: a first shell, the first shell comprising a sealed evacuated insulating space; a first component, the first component being disposed within the first shell and the first component comprising a material that is susceptible to inductive heating, the first component being disposed within the first shell, the first component being configured to receive a consumable; an induction heating coil, the induction heating coil being configured to give rise to inductive heating of the first component.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1 is a partial sectional view of a structure incorporating an insulating space according to the invention.

FIG. 2 is a sectional view of another structure according to the invention.

FIG. 3 is a sectional view of an alternative structure to that of FIG. 2 including a layer of spacer material on a surface of the insulation space.

FIG. 4 is a partial sectional view of a cooling device according to the invention.

FIG. 5 is a partial perspective view, in section, of an alternative cooling device according to the invention.

FIG. 6 is a partial perspective view, in section, of an end of the cooling device of FIG. 5 including an expansion chamber.

FIG. 7 is a partial sectional view of a cooling device having an alternative gas inlet construction from the cooling devices of FIGS. 4 through 6

FIG. 8 is a partial perspective view, in section, of a container according to the invention.

FIG. 9 is a perspective view, in section, of a Dewar according to the invention.

FIG. 10 provides a cutaway view of an embodiment of the disclosed technology.

FIG. 11A provides an illustrative embodiment of the disclosed technology;

FIG. 11B provides an illustrative embodiment of the disclosed technology;

FIG. 11C provides an illustrative embodiment of the disclosed technology;

FIG. 12A provides an illustrative embodiment of the disclosed technology;

FIG. 12B provides an illustrative embodiment of the disclosed technology; and

FIG. 12C provides an illustrative embodiment of the disclosed technology.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps may be performed in any order.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. All documents cited herein are incorporated herein in their entireties for any and all purposes.

Further, reference to values stated in ranges include each and every value within that range. In addition, the term “comprising” should be understood as having its standard, open-ended meaning, but also as encompassing “consisting” as well. For example, a device that comprises Part A and Part B may include parts in addition to Part A and Part B, but may also be formed only from Part A and Part B.

As explained in U.S. Pat. Nos. 7,681,299 and 7,374,063 (incorporated herein by reference in their entireties for any and all purposes), the geometry of an insulating space can be such that it guides gas molecules within the space toward a vent or other exit from the space. The width of the vacuum insulating space need not be not uniform throughout the length of the space. The space can include an angled portion such that one surface that defines the space converges toward another surface that defines the space. An insulating space can include a material (e.g., a ceramic thread, a ceramic ribbon, a ceramic ribbon) that reduces or eliminates direct contact between the walls between which the insulating space is formed.

As a result, the distance separating the surfaces can vary adjacent the vent such the distance is at a minimum adjacent the location at which the vent communicates with the vacuum space. The interaction between gas molecules and the variable-distance portion during conditions of low molecule concentration serves to direct the gas molecules toward the vent.

The molecule-guiding geometry of the space provides for a deeper vacuum to be sealed within the space than that which is imposed on the exterior of the structure to evacuate the space. This somewhat counterintuitive result of deeper vacuum within the space is achieved because the geometry of the present invention significantly increases the probability that a gas molecule will leave the space rather than enter. In effect, the geometry of the insulating space functions like a check valve to facilitate free passage of gas molecules in one direction (via the exit pathway defined by vent) while blocking passage in the opposite direction.

Another benefit associated with the deeper vacuums provided by the geometry of insulating space is that it is achievable without the need for a getter material within the evacuated space. The ability to develop such deep vacuums without a getter material provides for deeper vacuums in devices of miniature scale and devices having insulating spaces of narrow width where space constraints would limit the use of a getter material.

Other vacuum-enhancing features can also be included, such as low-emissivity coatings on the surfaces that define the vacuum space. The reflective surfaces of such coatings, generally known in the art, tend to reflect heat-transferring rays of radiant energy. Limiting passage of the radiant energy through the coated surface enhances the insulating effect of the vacuum space.

In some embodiments, an article can comprise first and second walls spaced at a distance to define an insulating space therebetween and a vent communicating with the insulating space to provide an exit pathway for gas molecules from the insulating space. The vent is sealable for maintaining a vacuum within the insulating space following evacuation of gas molecules through the vent.

The distance between the first and second walls is variable in a portion of the insulating space adjacent the vent such that gas molecules within the insulating space are directed towards the vent during evacuation of the insulating space. The direction of the gas molecules towards the vent imparts to the gas molecules a greater probability of egress than ingress with respect to the insulating space, thereby providing a deeper vacuum without requiring a getter material in the insulating space.

The construction of structures having gas molecule guiding geometry according to the present invention is not limited to any particular category of materials. Suitable materials for forming structures incorporating insulating spaces according to the present invention include, for example, metals, ceramics, metalloids, or combinations thereof.

The convergence of the space provides guidance of molecules in the following manner. When the gas molecule concentration becomes sufficiently low during evacuation of the space such that structure geometry becomes a first order effect, the converging walls of the variable distance portion of the space channel gas molecules in the space toward the vent.

The geometry of the converging wall portion of the vacuum space functions like a check valve or diode because the probability that a gas molecule will leave the space, rather than enter, is greatly increased.

The effect that the molecule-guiding geometry of structure has on the relative probabilities of molecule egress versus entry can be understood by analogizing the converging-wall portion of the vacuum space to a funnel that is confronting a flow of particles.

Depending on the orientation of the funnel with respect to the particle flow, the number of particles passing through the funnel would vary greatly. It is clear that a greater number of particles will pass through the funnel when the funnel is oriented such that the particle flow first contacts the converging surfaces of the funnel inlet rather than the funnel outlet.

Various examples of devices incorporating a converging wall exit geometry for an insulating space to guide gas particles from the space like a funnel are provided herein. It should be understood that the gas guiding geometry of the invention is not limited to a converging-wall funneling construction and may, instead, utilize other forms of gas molecule guiding geometries.

Some exemplary vacuum-insulated spaces (and related techniques for forming and using such spaces) can be found in, e.g., PCT/US2017/020651; PCT/US2017/061529; PCT/US2017/061558; PCT/US2017/061540; and United States published patent applications 2017/0253416; 2017/0225276; 2017/0120362; 2017/0062774; 2017/0043938; 2016/0084425; 2015/0260332; 2015/0110548; 2014/0090737; 2012/0090817; 2011/0264084; 2008/0121642; and 2005/0211711, all incorporated herein by reference in their entireties for any and all purposes. Such a space can be termed an Insulon™ space. It should be understood, however, that the foregoing constructions are illustrative only and that the disclosed technology need not necessarily be made according to any of the foregoing constructions.

### FIGURES

Provided here is additional detail concerning the attached, non-limiting figures.

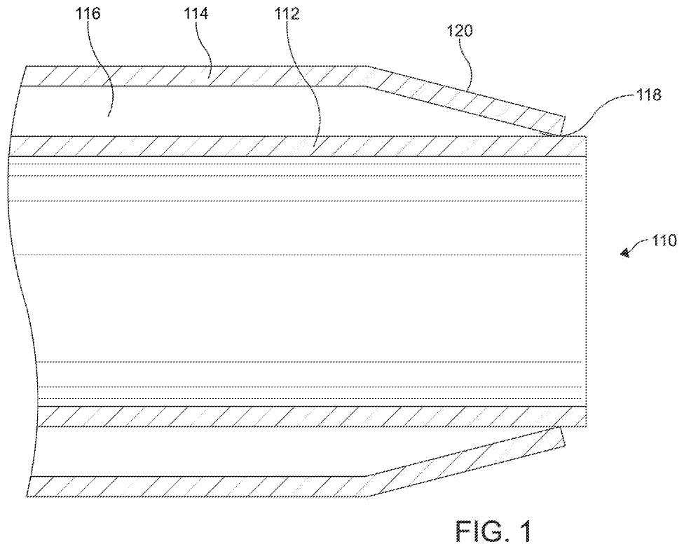

Referring to the drawings, where like numerals identify like elements, there is shown in FIG. 1 an end portion of a structure 110 according to the invention having gas molecule guiding geometry. Structure 110 appears in FIG. 1 at a scale that was chosen for clearly showing the gas molecule guiding geometry of the invention. The invention, however, is not limited to the scale shown and has application to devices of any scale from miniaturized devices to devices having insulating spaces of very large dimensions. Structure 110 includes inner and outer tubes 112, 114, respectively, sized and arranged to define an annular space 16 therebetween. The tubes 112, 114 engage each other at one end to form a vent 18 communicating with the vacuum space 116 and with an exterior. The vent 118 provides an evacuation path for egress of gas molecules from space 116 when a vacuum is applied to the exterior, such as when structure 110 is placed in a vacuum chamber, for example.

The vent 118 is sealable in order to maintain a vacuum within the insulating space following removal of gas molecules in a vacuum-sealing process. In its presently preferred form, the space 116 of structure 110 is sealed by brazing tubes 112, 114 together. The use of brazing to seal the evacuation vent of a vacuum-sealed structure is generally known in the art. To seal the vent 118, a brazing material (not shown) is positioned between the tubes 112, 114 adjacent their ends in such a manner that, prior to the brazing process, the evacuation path defined by the vent 118 is not blocked by the material. During the evacuation process, however, sufficient heat is applied to the structure 110 to melt the brazing material such that it flows by capillary action into the evacuation path defined by vent 118. The flowing brazing material seals the vent 118 and blocks the evacuation path. A brazing process for sealing the vent 118, however, is not a requirement of the invention. Alternative methods of sealing the vent 118 could be used, such as a metallurgical or chemical processes.

The geometry of the structure 110 effects gas molecule motion in the insulating space 116 in the following manner. A major assumption of Maxwell's gas law regarding molecular kinetic behavior is that, at higher concentrations of gas molecules, the number of interactions occurring between gas molecules will be large in comparison to the number of interactions that the gas molecules have with a container for the gas molecules. Under these conditions, the motion of the gas molecules is random and, therefore, is not affected by the particular shape of the container. When the concentration of the gas molecules becomes low, however, as occurs during evacuation of an insulating space for example, molecule-to-molecule interactions no longer dominate and the above assumption of random molecule motion is no longer valid. As relevant to the invention, the geometry of the vacuum space becomes a first order system effect rather than a second order system effect when gas molecule concentration is reduced during evacuation because of the relative increase in gas molecule-to-container interactions.

The geometry of the insulating space 116 guides gas molecules within the space 116 toward the vent 118. As shown in FIG. 1, the width of the annular space 116 is not uniform throughout the length of structure 110. Instead, the outer tube 114 includes an angled portion 120 such that the outer tube converges toward the inner tube 112 adjacent an end of the tubes. As a result the radial distance separating the tubes 112, 114 varies adjacent the vent 118 such that it is at a minimum adjacent the location at which the vent 118 communicates with the space 116. As will be described in greater detail, the interaction between the gas molecules and the variable-distance portion of the tubes 112, 114 during conditions of low molecule concentration serves to direct the gas molecules toward the vent 118.

The molecule guiding geometry of space 116 provides for a deeper vacuum to be sealed within the space 116 than that which is imposed on the exterior of the structure 110 to evacuate the space. This somewhat counterintuitive result of deeper vacuum within the space 116 is achieved because the geometry of the present invention significantly increases the probability that a gas molecule will leave the space rather than enter. In effect, the geometry of the insulating space 116 functions like a check valve to facilitate free passage of gas molecules in one direction (via the exit pathway defined by vent 118) while blocking passage in the opposite direction.

As shown in FIG. 1, the angled portion 120 of tube 114 of structure 110 extends to the end of tube 114 as tube 114 converges toward tube 112. This is not a requirement, however, as a tube can include an angled portion that does not extend all the way to the immediate end of the tube. As one example, a tube can have a first region having a first inner diameter, which first region transitions to an angled region having a variable diameter, which angled region transitions to a second region having a second inner diameter; the first and second regions can even be parallel to one another. (The second inner diameter can be smaller than the first inner diameter.)

A benefit associated with the deeper vacuums provided by the geometry of insulating space 116 is that it is achievable without the need for a getter material within the evacuated space 16. The ability to develop such deep vacuums without a getter material provides for deeper vacuums in devices of miniature scale and devices having insulating spaces of narrow width where space constraints would limit the use of a getter material.

Although not required, a getter material could be used in an evacuated space having gas molecule guiding structure according to the invention. Other vacuum enhancing features could also be included, such as low-emissivity coatings on the surfaces that define the vacuum space. The reflective surfaces of such coatings, generally known in the art, tend to reflect heat-transferring rays of radiant energy. Limiting passage of the radiant energy through the coated surface enhances the insulating effect of the vacuum space.

The construction of structures having gas molecule guiding geometry according to the present invention is not limited to any particular category of ceramics.

Suitable ceramic materials include, e.g., alumina (Al₂O₃, mullite, zirconia (ZrO₂) (including yttria-stabilized, yttira partially-stabilized, and magnesia partially-stabilized zirconia), silicon carbide, silicon nitride, and other glass-ceramic combinations.

Referring again to the structure 110 shown in FIG. 1, the convergence of the outer tube 114 toward the inner tube 112 in the variable distance portion of the space 116 provides guidance of molecules in the following manner. When the gas molecule concentration becomes sufficiently low during evacuation of space 116 such that structure geometry becomes a first order effect, the converging walls of the variable distance portion of space 16 will channel gas molecules in the space 16 toward the vent 18. The geometry of the converging wall portion of the vacuum space 16 functions like a check valve or diode because the probability that a gas molecule will leave the space 16, rather than enter, is greatly increased.

The effect that the molecule guiding geometry of structure 110 has on the relative probabilities of molecule egress versus entry can be understood by analogizing the converging-wall portion of the vacuum space 116 to a funnel that is confronting a flow of particles. Depending on the orientation of the funnel with respect to the particle flow, the number of particles passing through the funnel would vary greatly. It is clear that a greater number of particles will pass through the funnel when the funnel is oriented such that the particle flow first contacts the converging surfaces of the funnel inlet rather than the funnel outlet.

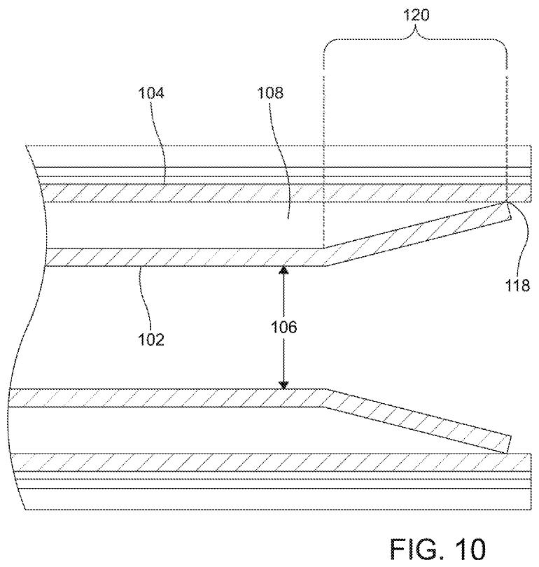

FIG. 10 provides a view of an alternative embodiment. As shown in that figure, an insulated article can include inner tube 102 and outer tube 104, which tubes define insulating space 108 therebetween. Inner tube 102 also defines a lumen within, which lumen can have a cross-section (e.g., diameter) 106. Insulating space 108 can be sealed by sealable vent 118. As shown in FIG. 10, inner tube 102 can include a portion 120 that flares outward toward outer tube 104, so as to converge towards outer tube 104.

The convergence of the outer tube 104 toward the inner tube 102 in the variable distance portion of the space 108 provides guidance of molecules in the following manner. When the gas molecule concentration becomes sufficiently low during evacuation of space 108 such that structure geometry becomes a first order effect, the converging walls of the variable distance portion of space 108 will channel gas molecules in the space 108 toward the vent 118. The geometry of the converging wall portion of the vacuum space 108 functions like a check valve or diode because the probability that a gas molecule will leave the space 108, rather than enter, is greatly increased.

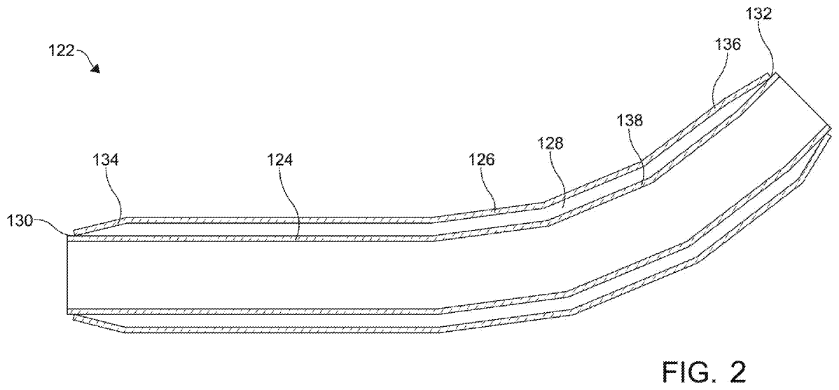

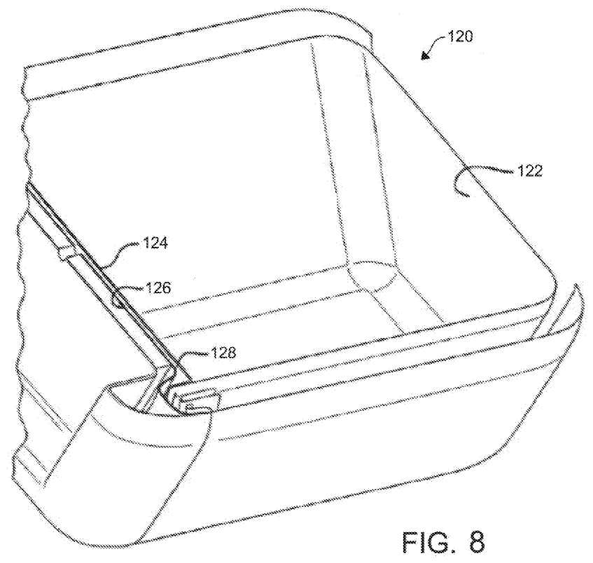

Various examples of devices incorporating a converging wall exit geometry for an insulating space to guide gas particles from the space like a funnel are shown in FIGS. 2-7. However, it should be understood that the gas guiding geometry of the invention is not limited to a converging-wall funneling construction and can, instead, utilize other forms of gas molecule guiding geometries. For example, the Dewar shown in FIG. 8 and described in greater detail below, incorporates an alternate form of variable distance space geometry according to the invention.

Insulated Probes

Referring to FIG. 2, there is shown a structure 122 incorporating gas molecule guiding geometry according to the invention. Similar to structure 110, structure 122 includes inner and outer tubes 124, 126 defining an annular vacuum space 28 therebetween. Structure 122 includes vents 130, 132 and angled portions 134, 136 of outer tube 126 at opposite ends that are similar in construction to vent 118 and angled portion 120 of structure 110 of FIG. 1.

The structure 122 can be useful, for example, in an insulated surgical probe. In such an application, it can be desirable that the structure 122 be bent as shown to facilitate access of an end of the probe to a particular target site. In some embodiments, the concentrically arranged tubes 124, 126 of structure 122 have been bent such that the resulting angle between the central axes of the opposite ends of the structure is approximately 45 degrees.

To enhance the insulating properties of the sealed vacuum layer, an optical coating 128 having low-emissivity properties can be applied to the outer surface of the inner tube 124. The reflective surface of the optical coating limits passage of heat-transferring radiation through the coated surface. The optical coating can comprise copper, a material having a desirably low emissivity when polished. Copper, however, is subject to rapid oxidation, which would detrimentally increase its emissivity. Highly polished copper, for example, can have an emissivity as low as approximately 0.02 while heavily oxidized copper can have an emissivity as high as approximately 0.78.

To facilitate application, cleaning, and protection of the oxidizing coating, the optical coating is preferably applied to the inner tube 124 using a radiatively-coupled vacuum furnace prior to the evacuation and sealing process. When applied in the elevated-temperature, low-pressure environment of such a furnace, any oxide layer that is present will be dissipated, leaving a highly cleaned, low-emissivity surface, which will be protected against subsequent oxidation within the vacuum space 128 when the evacuation path is sealed.

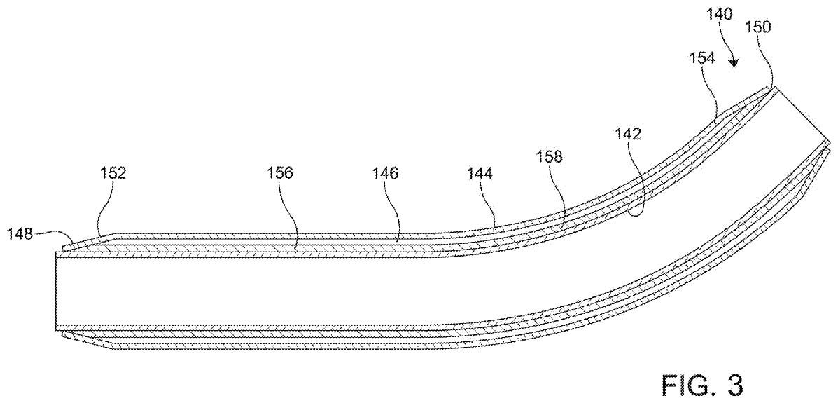

Referring to FIG. 3, there is shown another structure 140 incorporating having gas molecule guiding geometry according to the invention. Similar to structure 10 of FIG. 1, structure 140 includes inner and outer tubes 142, 144 defining an annular vacuum space 146 therebetween. Structure 140 includes vents 148, 150 and angled portions 152, 154 of outer tube 144 at opposite ends similar in construction to vent 118 and angled portion 120 of structure 110 of FIG. 1. Preferably, the concentrically arranged tubes 142, 144 of structure 140 have been bent such that the resulting angle between the central axes of the opposite ends of the structure is approximately 45 degrees. The structure 140, similar to structure 122 of FIG. 2, includes an optical coating 156 applied to the outer surface of inner tube 142.

When concentrically arranged tubes, such as those forming the vacuum spaces of the probes structures 122 and 140 of FIGS. 2 and 3, are subjected to bending loads, contact can occur between the inner and outer tubes while the loading is imposed. The tendency of concentric tubes bent in this fashion to separate from one another, or to “springback,” following removal of the bending loads can be sufficient to ensure that the tubes separate from each other. Any contact that does remain, however, could provide a detrimental “thermal shorting” between the inner and outer tubes, thereby defeating the intended insulating function for the vacuum space. To provide for protection against such thermal shorting, structure 140 of FIG. 3 includes a layer 158 of a spacer material, which is preferably formed by winding yarn or braid comprising micro-fibers of ceramic or other low conductivity material. The spacer layer 158 provides a protective barrier that limits direct contact between the tubes.

Each of the structures of FIGS. 1 to 3 could be constructed as a stand-alone structure. Alternatively, the insulating structures of FIGS. 1 to 3 could form an integrated part of another device or system. Also, the insulating structures shown in FIGS. 1 to 3 could be sized and arranged to provide insulating tubing having diameters varying from sub-miniature dimensions to very large diameter and having varying length. In addition, as described previously, the gas molecule guiding geometry of the invention allows for the creation of deep vacuum without the need for getter material. Elimination of getter material in the space allows for vacuum insulation spaces having exceptionally small widths.

Joule-Thomson Devices

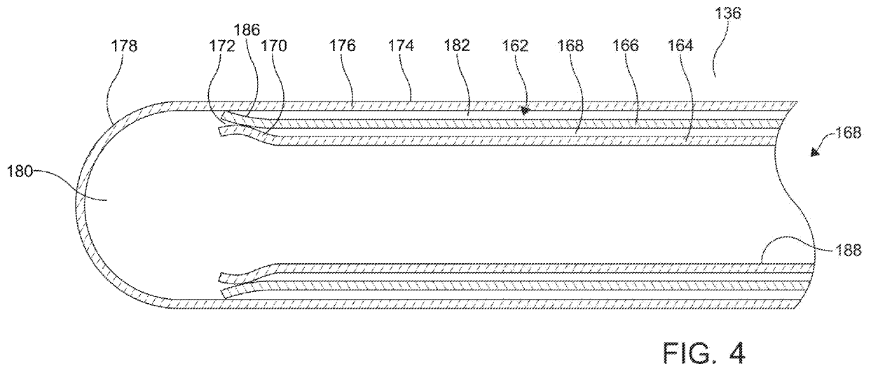

Referring to FIG. 4, there is shown a cooling device 160 incorporating gas molecule guiding geometry according to the present invention for insulating an outer region of the device 60. The device 60 is cooled utilizing the Joules-Thomson effect in which the temperature of a gas is lowered as it is expanded. First and second concentrically arranged tubes 164 and 166 define an annular gas inlet 168 therebetween. Tube 164 includes an angled portion 170 that converges toward tube 166. The converging-wall portions of the tubes 164, 166 form a flow-controlling restrictor or diffuser 172 adjacent an end of tube 164.

The cooling device 160 includes an outer jacket 174 having a cylindrical portion 176 closed at an end by a substantially hemispherical portion 178. The cylindrical portion 176 of the outer jacket 174 is concentrically arranged with tube 166 to define an annular insulating space 182 therebetween. Tube 166 includes an angled portion 184 that converges toward outer jacket 174 adjacent an evacuation path 186. The variable distance portion of the insulating space 182 differs from those of the structures shown in FIGS. 1-3 because it is the inner element, tube 164, that converges toward the outer element, the cylindrical portion 176. The functioning of the variable distance portion of insulating space 182 to guide gas molecules, however, is identical to that described above for the insulating spaces of the structures of FIGS. 1-3.

The annular inlet 168 directs gas having relatively high pressure and low velocity to the diffuser 172 where it is expanded and cooled in the expansion chamber 180. As a result, the end of the cooling device 160 is chilled. The expanded low-temperature/low-pressure is exhausted through the interior of the inner tube 164. The return of the low-temperature gas via the inner tube 164 in this manner quenches the inlet gas within the gas inlet 168. The vacuum insulating space 182, however, retards heat absorption by the quenched high-pressure side, thereby contributing to overall system efficiency. This reduction in heat absorption can be enhanced by applying a coating of emissive radiation shielding material on the outer surface of tube 166. The invention both enhances heat transfer from the high-pressure/low-velocity region to the low-pressure/low-temperature region and also provides for size reductions not previously possible due to quench area requirements necessary for effectively cooling the high pressure gas flow.

The angled portion 170 of tube 164, which forms the diffuser 172, can be adapted to flex in response to pressure applied by the inlet gas. In this manner, the size of the opening defined by the diffuser 172 between tubes 164 and 166 can be varied in response to variation in the gas pressure within inlet 168. An inner surface 188 of tube 164 provides an exhaust port (not seen) for removal of the relatively low-pressure gas from the expansion chamber 180.

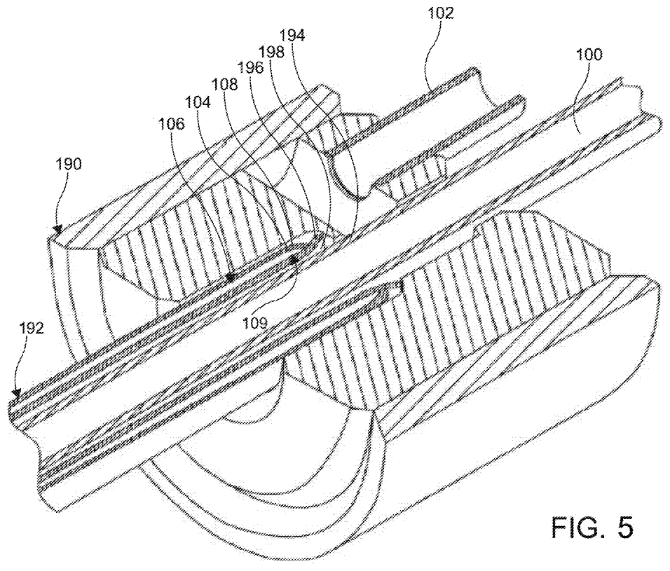

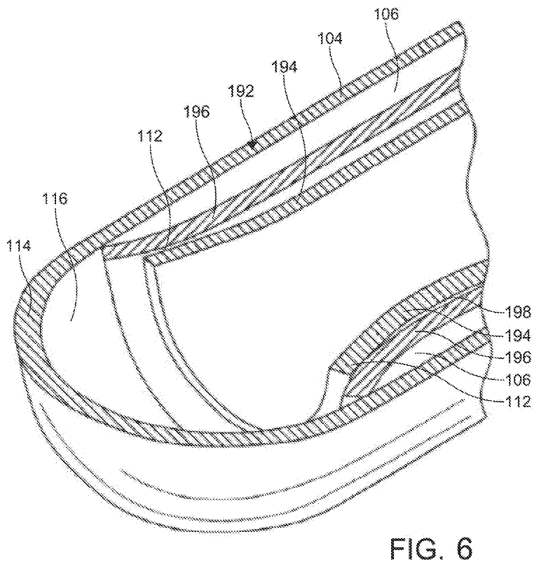

Referring to FIGS. 5 and 6, there is shown a cryogenic cooler 190 incorporating a Joules-Thomson cooling device 192. The cooling device 192 of the cryogenic cooler 190, similar to the device of FIG. 4, includes tubes 194 and 196 defining a high pressure gas inlet 198 therebetween and a low-pressure exhaust port 100 within the interior of tube 94. The gas supply for cooling device 190 is delivered into cooler 190 via inlet pipe 102. An outer jacket 104 forms an insulating space 106 with tube 96 for insulating an outer portion of the cooling device. The outer jacket 104 includes an angled portion 108 that converges toward the tube 196 adjacent an evacuation path 109. The converging walls adjacent the evacuation path 109 provides for evacuation and sealing of the vacuum space 106 in the manner described previously.

Referring to FIG. 6, the cooling device 192 of the cryogenic cooler 190 includes a flow controlling diffuser 112 defined between tubes 194 and 196. A substantially hemispherical end portion 114 of outer jacket 104 forms an expansion chamber 116 in which expanding gas from the gas inlet 198 chills the end of the device 192.

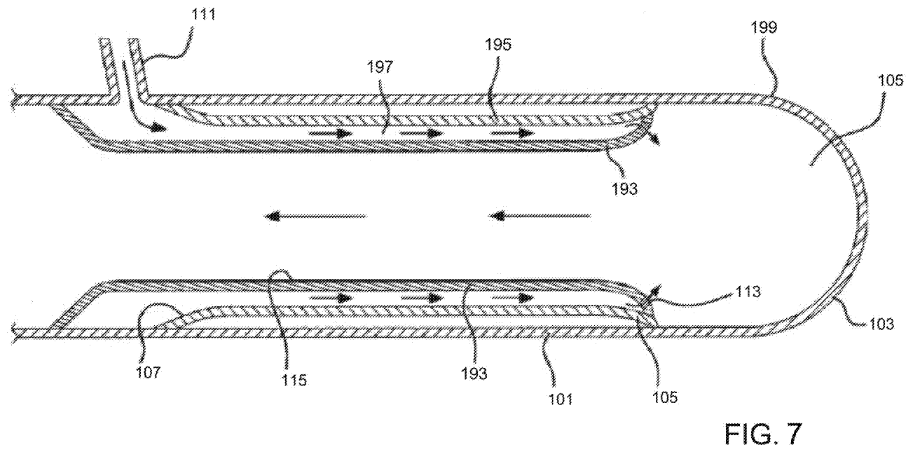

Referring to FIG. 7, there is shown a cooling device 191 including concentrically arranged tubes 193, 195 defining an annular gas inlet 197 therebetween. An outer jacket 199 includes a substantially cylindrical portion 101 enclosing tubes 193, 195 and a substantially semi-spherical end portion 103 defining an expansion chamber 105 adjacent an end of the tubes 193, 195. As shown, tube 195 includes angled or curved end portions 105, 107 connected to an inner surface of the outer jacket 199 to form an insulating space 109 between the gas inlet 197 and the outer jacket 199. A supply tube 111 is connected to the outer jacket adjacent end portion 107 of tube 195 for introducing gas into the inlet space 97 from a source of the gas.

The construction of the gas inlet 197 of cooling device 191 adjacent the expansion chamber 105 differs from that of the cooling devices shown in FIGS. 4-6, in which an annular escape path from the gas inlet was provided for delivering gas into the expansion chamber. Instead, tube 193 of cooling device 191 is secured to tube 195 adjacent one end of the tubes 193, 195 to close the end of the gas inlet. Vent holes 113 are provided in the tube 193 adjacent the expansion chamber 105 for injection of gas into the expansion chamber 105 from the gas inlet 197. Preferably, the vent holes 113 are spaced uniformly about the circumference of tube 193. The construction of device 191 simplifies fabrication while providing for a more exact flow of gas from the gas inlet 197 into the expansion chamber 105.

A coating 115 of material having a relatively large thermal conductivity, preferably copper, is formed on at least a portion of the inner surface of tube 193 to facilitate efficient transfer of thermal energy to the tube 193.

Non Annular Devices

Each of the insulating structures of FIGS. 1-7 includes an insulating vacuum space that is annular. An annular vacuum space, however, is not a requirement of the invention, which has potential application in a wide variety of structural configurations. Referring to FIG. 8, for example, there is shown a vacuum insulated storage container 120 having a substantially rectangular inner storage compartment 122. The compartment 122 includes substantially planar walls, such as wall 124 that bounds a volume to be insulated. An insulating space 128 is defined between wall 124 and a second wall 126, which is closely spaced from wall 124. Closely spaced walls (not shown) would be included adjacent the remaining walls defining compartment 122 to provide insulating spaces adjacent the container walls. The insulating spaces could be separately sealed or, alternatively, could be interconnected. In a similar fashion as the insulating structures of FIGS. 1-7, a converging wall portion of the insulating space 128 (if continuous), or converging wall portions of insulating spaces (if separately sealed), are provided to guide gas molecules toward an exit vent. In the insulated storage container 120, however, the converging wall portions of the insulated space 128 is not annular.

The vacuum insulated storage container 120 of FIG. 8 provides a container capable of indefinite regenerative/self-sustaining cooling/heating capacity with only ambient energy and convection as input energy. Thus, no moving parts are required. The storage container 120 can include emissive radiation shielding within the vacuum insulating envelope to enhance the insulating capability of the vacuum structure in the manner described previously.

The storage container 120 can also include an electrical potential storage system (battery/capacitor), and a Proportional Integrating Derivative (PID) temperature control system for driving a thermoelectric (TE) cooler or heater assembly. The TE generator section of the storage container would preferably reside in a shock and impact resistant outer sleeve containing the necessary convection ports and heat/light collecting coatings and or materials to maintain the necessary thermal gradients for the TE System. The TE cooler or heater and its control package would preferably be mounted in a removable subsection of a hinged cover for the storage container 120. An endothermic chemical reaction device (e.g., a “chemical cooker”) could also be used with a high degree of success because its reaction rate would relate to temperature, and its effective life would be prolonged because heat flux across the insulation barrier would be exceptionally low.

Commercially available TE generator devices are capable of producing approximately 1 mW/in² with a device gradient of 20 deg. K approximately 6 mW/in² with a device gradient of 40 deg. K. Non-linear efficiency curves are common for these devices. This is highly desirable for high ambient temperature cooling applications for this type of system, but can pose problems for low temperature heating applications.

High end coolers have conversion efficiencies of approximately 60%. For example a 10 inch diameter container 10″ in height having 314 in² of surface area and a convective gradient of 20 deg. K would have a total dissipation capacity of approximately 30 mW. A system having the same mechanical design with a 40 .degree. K convective gradient would have a dissipation capacity of approximately 150 mW.

Examples of potential uses for the above-described insulated container 120 include storage and transportation of live serums, transportation of donor organs, storage and transportation of temperature products, and thermal isolation of temperature sensitive electronics.

Alternate Molecule Guiding Geometry

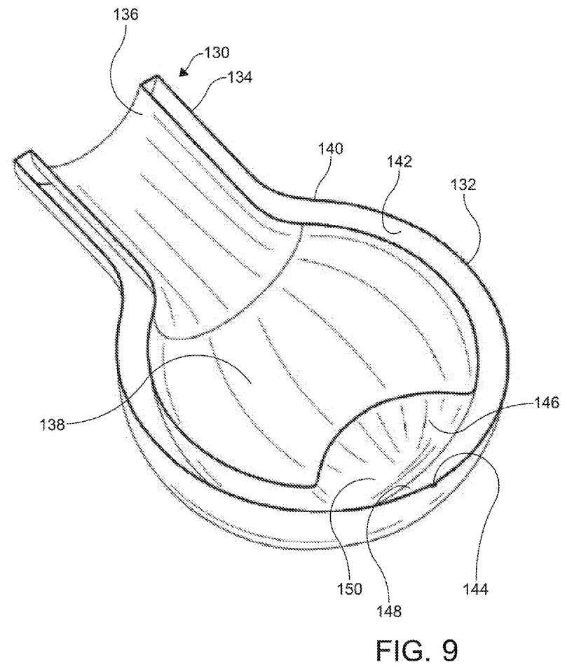

The present invention is not limited to the converging geometry incorporated in the insulated structure shown in FIGS. 1-8. Referring to FIG. 9, there is shown a Dewar 130 incorporating an alternate form of gas molecule guiding geometry according to the invention. The Dewar 130 includes a rounded base 132 connected to a cylindrical neck 134. The Dewar 130 includes an inner wall 136 defining an interior 138 for the Dewar. An outer wall 140 is spaced from the inner wall 136 by a distance to define an insulating space 142 therebetween that extends around the base 132 and the neck 134. A vent 144, located in the outer wall 140 of the base 132, communicates with the insulating space 142 to provide an exit pathway for gas molecules during evacuation of the space 142.

A lower portion 146 of the inner wall 136 opposite vent 144 is indented towards the interior 138, and away from the vent 144. The indented portion 146 forms a corresponding portion 148 of the insulating space 142 in which the distance between the inner and outer walls 136, 140 is variable. The indented portion 146 of inner wall 136 presents a concave curved surface 150 in the insulating space 142 opposite the vent 144. Preferably the indented portion 146 of inner wall 136 is curved such that, at any location of the indented portion a normal line to the concave curved surface 150 will be directed substantially towards the vent 144. In this fashion, the concave curved surface 150 of the inner wall 136 is focused on vent 144. The guiding of the gas molecules towards the vent 144 that is provided by the focused surface 150 is analogous to a reflector returning a focused beam of light from separate light rays directed at the reflector. In conditions of low gas molecule concentration, in which structure becomes a first order system effect, the guiding effect provided by the focused surface 150 serves to direct the gas molecules in a targeted manner toward the vent 144. The targeting of the vent 144 by the focused surface 150 of inner wall 136 in this manner increases the probability that gas molecules will leave the insulating space 142 instead of entering thereby providing deeper vacuum in the insulating space than vacuum applied to an exterior of the Dewar 130.

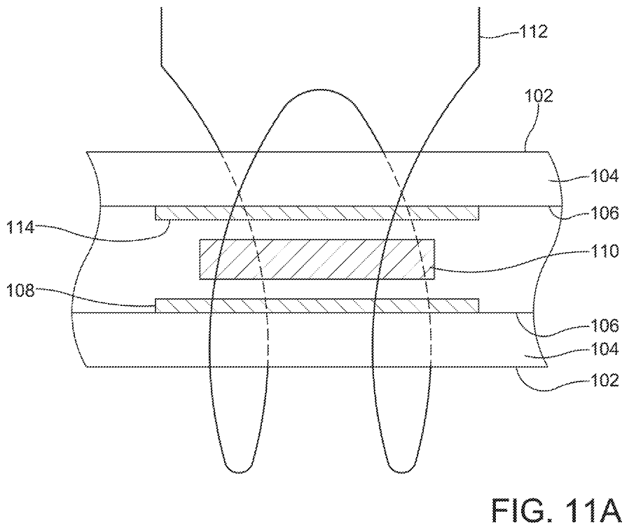

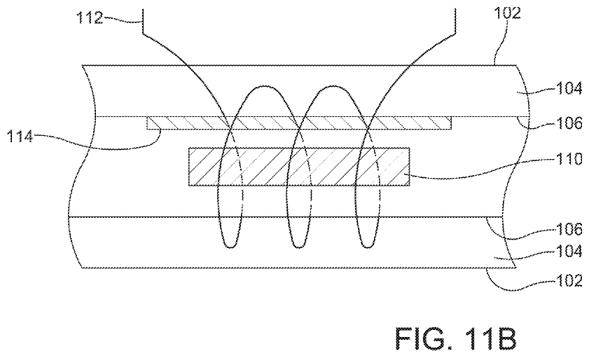

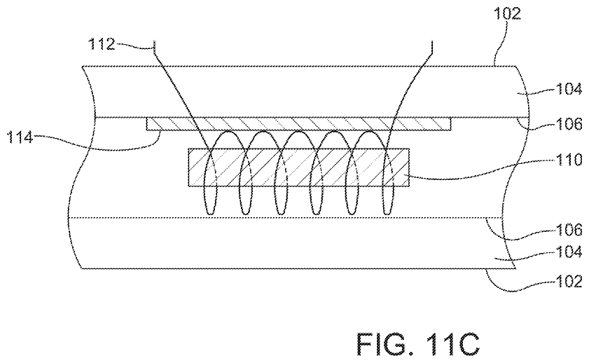

FIG. 11A provides a non-limiting, cutaway illustration of an article according to the present disclosure.

As shown in FIG. 11A, an insulating module can include a first shell 1102. A module can further include a first component 1106. As shown, first component 1106 can be a tube, but this is not a requirement, as first component 1106 can be solid, e.g., be cylindrical. A sealed, evacuated insulating space 1104 can be disposed between first shell 1102 and first component 1106. Example sealed, evacuated insulating spaces (and related techniques for forming and using such spaces) can be found in, e.g., PCT/US2017/020651; PCT/US2017/061529; PCT/US2017/061558; PCT/US2017/061540; and United States published patent applications 2017/0253416; 2017/0225276; 2017/0120362; 2017/0062774; 2017/0043938; 2016/0084425; 2015/0260332; 2015/0110548; 2014/0090737; 2012/0090817; 2011/0264084; 2008/0121642; and 2005/0211711, all of which are incorporated herein by reference in their entireties for any and all purposes.

A module can also include an amount of working material 1110. Working material 1110 can be heat-sensitive, e.g., material 1110 can undergo a phase change (e.g., from solid to liquid, from solid to vapor, from solid to smoke, and the like) upon exposure to heating. Working material 1110 can be a solid, but can also be semisolid. Working material 1110 can be heated so as to liquefy, as an example. Alternatively, working material 1110 can be heated so as to vaporize or smoke. Working material 1110 can be combusted, but can also be heated without combustion, e.g., in a heat-not-burn fashion.

Although not shown, a module according to the present disclosure can include one or more sensors. A sensor can be, for example, a temperature sensor, a pressure sensor, a humidity sensor. Other sensors besides the foregoing are also contemplated. As an example, a module according to the present disclosure can include a temperature sensor that monitors a temperate within first component 1106. A temperature sensor can also be configured to monitor a temperature in the environment surrounding working material 1110. A temperature sensor can also be configured to monitor a temperature of one or both of elements 1114 and 1118 as shown in FIG. 11A, which elements are described further herein.

Working material 1110 can also comprise pores, channels, or other voids therein. Additionally, working material 1110 can be a single “unibody” piece of working material such as an ingot or wire, but can also be multiple portions of material, e.g., individual segments, particulates, flakes, and the like. Working material 1110 can be a consumable cartridge or insert.

Polymeric materials are considered suitable working materials, but there is no limitation on the working material that can be disposed within the module. A working material can comprise a metal, a wax, and the like.

Modules according to the present disclosure can also include a current collector 1112. As shown, a current collector can be present as a coil, and can, in some embodiments, be disposed about the first shell 1102, as shown in exemplary FIG. 11A. Without being bound to any particular embodiment, a current collector can be configured as an induction coil that induces inductive heating within (or outside of) a module according to the present disclosure. A module can include one or more portions of magnetic shielding; such shielding can be used to shield one or more elements of the module from magnetic and/or electric fields or current. It should be understood that current collector 1112 need not be present in coil form. In some embodiments, current collector 1112 can be of the form of one or more wires that are arranged opposite one another such that alternating or sequential application of current through the wires gives rise to inductive heating of material (e.g., working material, a metal element that is used as a heating material) that is disposed between the wires.

A coiled current collector is considered especially suitable, as such a configuration can be used to effect inductive heating of a working material disposed within the coil. Without being bound to any particular theory, a power supply (e.g., a solid state RF) can sent a current through the current collector. The frequency of the current can be constant or varied. Frequencies in the range of from about 5 to about 30 kHz can be useful with comparatively thick working materials (e.g., a rod having a diameter of 50 mm or greater). Frequencies in the range of about 100 to about 400 kHz can be useful with comparatively smaller workpieces or where relatively shallow heat penetration is desirable. Frequencies of 400 kHz or higher can be useful with especially small workpieces.

A current collector can be cooled (e.g., air-cooled or even liquid-cooled). A current collector can be a solid (i.e., not hollow), but can also be hollow in configuration.

A working material can be placed within the current collector. The current collector serves as the transformer primary and working material (to be heated) becomes a short circuit secondary. Circulating eddy currents are then induced within the working material. The eddy currents can flow against the electrical resistivity of the working material, which in turn creates heat without physical contact between the current collector and the working material.

Additional heat can be produced within magnetic parts through hysteresis—internal friction that is created when magnetic parts pass through the current collector. Magnetic working materials naturally offer electrical resistance to the rapidly changing magnetic fields within the inductor. This resistance produces internal friction that in turn produces heat. In the process of heating the working material, there need be no contact between the inductor and the working material. The working material to be heated can be located in a setting isolated from the power supply.

A module can also include a first element 1108, though it should be understood that such an element is optional. Such a first element can be metallic, and can be disposed within the first component 1106. The first element can be present as a wire, a ribbon, a coil, a layer, a coating, or in essentially any form. In some embodiments, first element 1108 can be a sleeve or ring that extends at partially circumferentially around the lumen of the first component 1106. In some embodiments, the first element is inductively heated by the current collector.

In some embodiments, a module can include a second element 1114. First element 1108 and second element 1114 can be formed of the same material or of different materials. In some embodiments, one or both of the first and second elements are inductively heated by the current collector. As an example, one or both of first element 1108 and 1114 can be formed of a metal or other material that can be inductively heated.

A module can be configured such that the material 1110 contacts the first element 1108 and/or second element 1114, though this is not a requirement. As one example, working material 1110 can be heated via element 1108 and/or 1114 via convective and/or radiative heating. In some embodiments, first component 1106 is inductively heated by the current collector 1112. In some embodiments, the working material 1110 is capable of being inductively heated or comprises a component that is capable (e.g., a metal) of being inductively heated.

As shown, first component 1106 can define a lumen (not labeled) within. In the example embodiment shown in FIG. 11A, working material 1110 is disposed within the lumen of first component 1106. Working material 1110 can be slidably introduced into a module, e.g., in the manner of a cartridge or other insert that is inserted into the module.

It should be understood, however, that first element 1108 and second element 1114 are optional and are not required. As an example, shell 1102 can be formed of a ceramic (or other material that is not susceptible to inductive heating), and first component 1106 can be formed of a material (e.g., a metal) that is susceptible to inductive heating. In this way, operation of current collector 1112 gives rise to inductive heating of first component 1106, which in turn heats working material 1110. In some embodiments, both shell 1102 and first component 1116 are non-susceptible to inductive heating, and one or both of first element 1108 and second element 1114 (if present) are inductively heated by operation of current collector 1112. (In such embodiments, one or both of first element 1108 and 1114 are metal or other material that is susceptible to inductive heating.)

In some embodiments, both shell 1102 and first component 1106 are formed of material that is susceptible to inductive heating. (It is not a requirement that shell 1102 and first component 1106 be formed of the same material.) In some embodiments, shell 1102 is formed of a material that is susceptible to inductive heating, and first component 1106 is formed of a material that is not susceptible to inductive heating. As described elsewhere herein, shell 1102 can be formed of a material that is not susceptible to inductive heating and first component 1106 is formed of a material that is susceptible to inductive heating. (Shell 1102 and first component 1106 can also be comprised such that shell 1102 is more susceptible to inductive heating than first component 1106; shell 1102 and first component 1106 can also be comprise such that first component 1106 is more susceptible to inductive heating than shell 1102.)

Although working material 1110 is shown in FIG. 11A as being within the lumen of first component 1106, this is not a requirement, as the working material 1110 can be disposed exterior to shell 1102, e.g., as a ring, tube, or other form that at least partially encircles shell 1102. In some such embodiments, shell 1102 can be formed of a material that is susceptible to inductive heating. In this way, a current collector can be used to effect inductive heating of shell 1102, which in turn heats a working material that is disposed about shell 1102.

In some such embodiments, an element (e.g., a metallic ring, coating, or layer) is disposed about shell 1102. Such an element can be susceptible to inductive heating. In this way, a current collector can be used to effect inductive heating of the element (and, depending on the material of shell 1102, of shell 1102), which in turn heats a working material that is disposed about shell 1102.

In some embodiments, a module can operate so as to effect heating of material disposed exterior to shell 1102 and material that is disposed within shell 1102. By taking advantage of the evacuated space 1104 between shell 1102 and first component 1106, a module according to the present disclosure can give rise to heating different materials (interior to shell 1102 and exterior to shell 1102) at different heating levels. For example (and by reference to FIG. 11A), a material disposed exterior to shell 1102 can be heated inductively by shell 1102 (and/or by an element disposed exterior to shell 1102) at a first level of heating, and a material disposed within first component 1106 at a second level of heating, as the material exterior to shell 1102 is thermally insulated (by way of evacuated space 1104) from the material within first component 1106.

A module according to the present disclosure can include (not shown) a receiving component (e.g., a holder) that receives working material 1110 and maintains working material 1110 in position within the module. The receiving component can maintain working material 1110 at a distance from first component 1106. Alternatively, the receiving component can be configured to maintain the working material about shell 1102, e.g., when the working material is present as a sleeve or tube that at least partially encloses shell 1102.

An alternative embodiment is shown in FIG. 11B. As shown in FIG. 11B, a module can include a first shell 1102. A module can further include a first component 1106. As shown, first component 1106 can be a tube, but this is not a requirement, as first component 1106 can be solid, e.g., be cylindrical. A sealed, evacuated insulating space 1104 can be disposed between first shell 1102 and first component 1106.

A module can also include an amount of working material 1110. Working material 110 can be heat-sensitive, e.g., working material 1110 can undergo a phase change upon exposure to a certain temperature. Working material 1110 can be a solid, but can also be semisolid.

Working material 1110 can also comprise pores, channels, or other voids therein. Additionally, working material 1110 can be a single “unibody” piece of working material such as an ingot or wire, but can also be multiple portions of working material, e.g., individual segments, particulates, flakes, and the like. Polymeric working materials are considered especially suitable, but there is no limitation on the working material that can be disposed within the module.

Modules according to the present disclosure can also include a current collector 112. As shown, a current collector can be present as a coil, and can, in some embodiments, be disposed within the insulating space 1104, as shown in example FIG. 11B. Without being bound to any particular embodiment, a current collector can be configured as an induction coil that induces inductive heating within (or outside of) a module according to the present disclosure.

A module can also include an element 1114, though such an element is optional. Such a first element can be metallic, and can be disposed within the first component 1106. The first element can be present as a wire, a ribbon, a coil, or in essentially any form. In some embodiments, the first element is inductively heated by the current collector.

In some embodiments, the element is inductively heated by the current collector. A module can be configured such that the working material 1110 contacts the element 1114, though this is not a requirement. In some embodiments, first component 1106 is inductively heated by the current collector 1112. In some embodiments, the working material 1110 is capable of being inductively heated or comprises a component that is capable (e.g., a metal) of being inductively heated.

An further alternative embodiment is shown in FIG. 11C. As shown in FIG. 11C, a module can include a first shell 1102. A module can further include a first component 1106. As shown, first component 1106 can be a tube, but this is not a requirement, as first component 1106 can be solid, e.g., be cylindrical. A sealed, evacuated insulating space 1104 can be disposed between first shell 1102 and first component 1106.

A module can also include an amount of working material 1110. Working material 110 can be heat-sensitive, e.g., working material 1110 can undergo a phase change upon exposure to a certain temperature.

Working material 1110 can be a solid, but can also be semisolid. Material 1110 can also comprise pores, channels, or other voids therein. Additionally, working material 1110 can be a single “unibody” piece of working material such as an ingot or wire, but can also be multiple portions of working material, e.g., individual segments, particulates, flakes, and the like. Polymeric working materials are considered especially suitable, but there is no limitation on the working material that can be disposed within the module.

Modules according to the present disclosure can also include a current collector 1112. As shown, a current collector can be present as a coil, and can, in some embodiments, be disposed within the first component 1106. Without being bound to any particular embodiment, a current collector can be configured as an induction coil that induces inductive heating within (or outside of) a module according to the present disclosure.

A module can also include an element 1114, though such an element is optional. Such an element can be metallic, and can be disposed within the first component 1106. (For convenience, FIGS. 11B and 11C each show only one element disposed within the first component. It should be understood, however, that a module according to the present disclosure can include zero, one, two, or more such elements.)

The first element can be present as a wire, a ribbon, a coil, or in essentially any form. In some embodiments, the first element is inductively heated by the current collector.

In some embodiments, the element is inductively heated by the current collector. A module can be configured such that the working material 1110 contacts the element 1114, though this is not a requirement. In some embodiments, first component 1106 is inductively heated by the current collector 1112. In some embodiments, the working material 1110 is capable of being inductively heated or comprises a component that is capable (e.g., a metal) of being inductively heated. As shown in FIG. 11C, current collector 1112 can be disposed within a lumen of first component 1106.

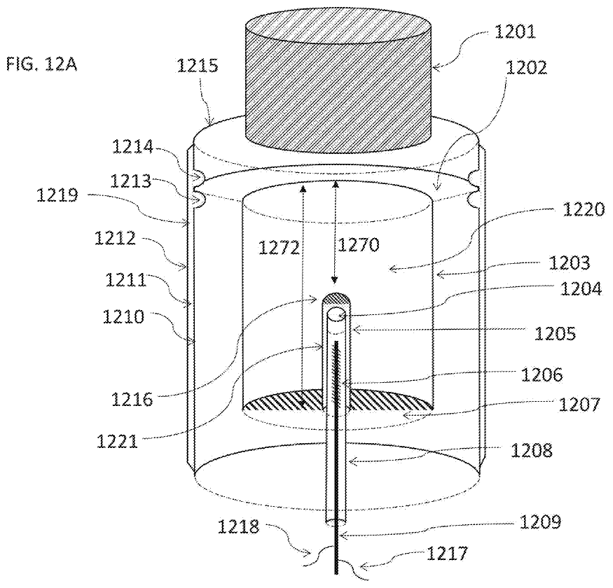

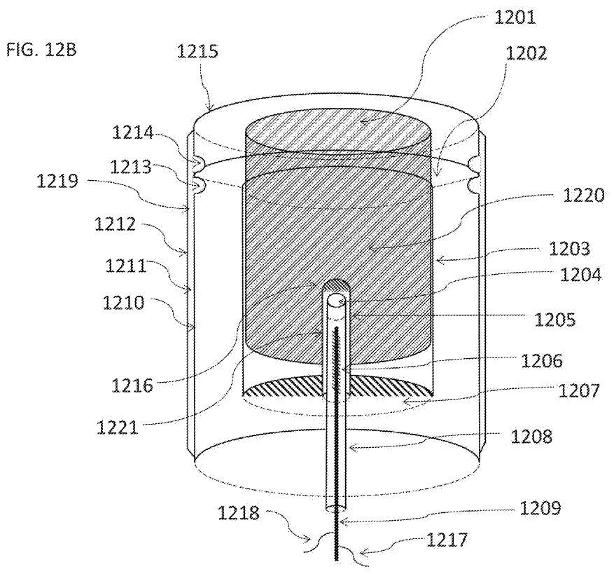

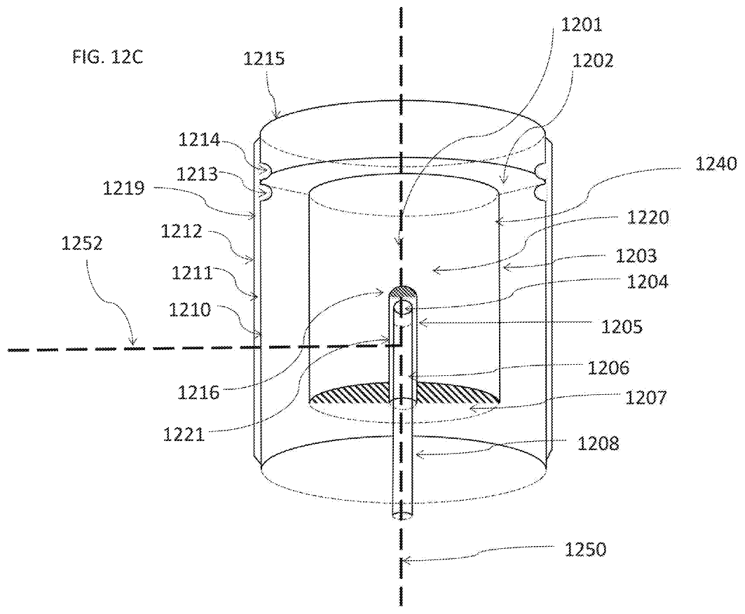

Another embodiment is provided in non-limiting FIG. 12A. As shown in that figure, a module according to the present disclosure can include a first component 1203. First component 1203 can be formed from a material that is susceptible to induction heating, e.g., a ferrous metal or a material that comprises a ferrous metal.

First component 1203 can be present as, e.g., a tube, a cylinder, a can, or other shapes. First component 1203 can include a feature 1202 (e.g., a flange) that is used to locate first component 1203 within the module. As shown in non-limiting FIG. 12, flange 1202 is engaged with locating features 1212 and 1213 of the module. Locating features can be, e.g., flanges, protrusions, ridges, slots, tabs, grooves, and the like. First component 1203 can include one or more wrinkles, corrugations, or other features that can expand or contract in response to a change in temperature. Without being bound to any particular theory, such features can accommodate (e.g, via expansion) stresses in the first component that results from temperature change in order to reduce or even eliminate forces that the first component might otherwise exert against other elements of the module as the first component is heated and/or cools.

First component 1203 can be disposed within first shell 1219. First shell 1219 can have an outer wall 1212 and inner wall 1210. Though not a requirement, one can arrange the components so as to minimize the distance between first component 1203 and inner wall 1210. First shell 1219 can be tubular in configuration, but can also be formed as a can, having a bottom, or even a bottom and top. First shell 1219 can be circular in cross-section, but this is not a requirement, as first shell 1219 can be of other (e.g., polygonal, ovoid) cross-sections.

It should also be understood that one or both of outer wall 1212 and inner wall 1210 of first shell 1219 can comprise a material (e.g., a ferrous material) that is susceptible to induction heating. In some embodiments, e.g., those where a portion of first shell 1219 is susceptible to induction heating, first component 1203 can be optional.

A sealed evacuated space 1211 can be defined between outer wall 1212 and inner wall 1210 of first shell 1219. Suitable such spaces are described elsewhere herein. Inner wall 1210 can be formed from a material that is non-ferrous and is not susceptible to inductive heating. Likewise, outer wall 1212 can be formed from a material that is non-ferrous and is not susceptible to inductive heating. Ceramic materials can be used as such non-ferrous materials. First shell 1219 can include an upper rim 1215.

As shown in FIG. 12, the module can include a cup 1205, which cup can be formed in first component 1203. As shown, cup 1205 can be formed as a depression (which can also be termed a pouch or invagination) in portion of first component 1203, e.g., in the bottom of first component 1203 when first component 1203 is in the form of a can with a bottom. The cup can have an end 1216. End 1216 can include a point, ridge, or other profile that is useful in penetrating into a material. A consumable used in conjunction with the disclosed modules can include a recess or other feature into which end 1216 can fit. End 1216 can be located at a distance from an end of first component 1203. As an example, end 1216 can be located at a distance relative to an end of first component 1203 as measured along a central axis of first component 1203 that is coaxial with cup 1205. As shown in FIG. 12, cup 1205 can be connected to a wall of first component 1203, e.g., via surface 1207 of first component 1203; in some embodiments, cup 1205 is part of first component 1205. In some embodiments, first component 1203 is formed of a single piece of material, which piece of material also defines cup 1205. Although not shown, first component 1203 can include one or more apertures formed therein.

Also as shown, first component 1203 can define an interior volume 1220. The interior volume 1220 can be defined by the interior surface of first component 1203. As shown, the interior surface of the exemplary first component 1203 defined by the interior surface 1240 of first component 1203, as well as by the surface 1221 of cup 1205. Interior volume 1220 can be used to at least partially contain a working material, e.g., a consumable. As shown, interior volume can define a height 1272.

A module can include an induction coil 1206. A heating coil can be in electronic communication with one or more leads; example leads 1217 and 1218 are shown in FIG. 12. Induction coil 1206 can be at least partially enclosed within coil container 1208. Coil container 1208 can comprise inner and outer walls that define a sealed evacuated space (not labeled) therebetween. Coil container 1208 can be tubular in configuration, but can also be a can in configuration, with tubular walls and a top, shown as 1204 in FIG. 12A. Top 1204 can also define a sealed evacuated space. A module can also include a flange, jig, or other component configured to maintain the induction coil in position.

Coil container 1208 can comprise a ceramic material, and can be magnetically transparent. In this way, current in induction coil 1206 can effect heating of cup 1205, while reducing the amount of loss as the magnetic field crosses coil container 1208. Coil container 1208 can comprise ceramic walls that define a sealed evacuated space therebetween; suitable such spaces are described elsewhere herein. A sealed, evacuated space can be present between cup 1205 and coil container 1208, in some embodiments.

As shown in FIG. 12B, consumable 1201 can be inserted into the module, and can be at least partially contained within interior volume 1220. End 1216 can extend into consumable 1201. As described elsewhere herein, end 1216 can be configured as a point, a ridge, a crimp, an edge, or other modality configured to penetrate into consumable 1201. Consumable 1201 can comprise a solid, but can also comprise a fluid, e.g., a liquid or even a gas. A module can also include a flange, jig, collar, or other element configured to maintain the consumable in place. A module can include (not shown) an opening (and/or a closure) into which a consumable can be introduced and/or retrieved. A closure can be a thermal insulator; as one example, the closure can include walls with a sealed evacuated space defined therebetween. (Suitable such spaces are described elsewhere herein.) A closure can be formed of a non-ferrous material that is not susceptible to inductive heating.

As shown, end 1216 can be at a distance 1270 from an end of interior volume 1220. The ratio of distance 1270 to height 1272 can be from, e.g., 1:1000 to 1:1. In some embodiments, end 1216 can extend beyond interior volume 1220.

In operation, induction coil 1206 can be operated so as to give rise to heating of first component 1203, which in turn gives rise to heating of consumable 1201. By having induction coil 1206 effectively located within consumable 1201, a user can heat consumable 1201 from inside (via induction heating effected in cup 1205) and also from outside (via induction heating of portions of first component 1203 that contact or face consumable 1201). This configuration thus provides for efficient heating of consumable 1201. The disclosed configuration also provides for heating of the consumable (via inductive heating) while maintaining thermal insulation (via the insulating capability of first shell 1219) between the heated consumable and the user.

In some embodiments, consumable 1201 includes an amount of a material that is susceptible to inductive heating, e.g., an amount of a ferrous material. In some embodiments, the induction coil operates to effect heating of such material in the consumable.

The present configuration also acts to thermally insulate coil 1216 from the inductively heated cup 1205 and the first component 1203. This thermal insulation is accomplished by the thermal insulating capability of coil container 1208. As described elsewhere herein, a module can be operated to effect combustion of the consumable 1201, but can also be operated so as to heat the consumable without burning the consumable.

The disclosed modules (and any document cited herein) can also include an additional amount of heat transfer material (e.g., metal, carbon black, graphite (including pyrolytic graphite), and the like). Such heat transfer material can be used where improved heat transfer is advantageous; e.g., along surface 1240 of first component 1203 as shown in FIG. 12A, along surface 1221, or in other locations.

By reference to FIG. 12A, further embodiments are described. As one example, first component 1203 need not necessarily be present. In such embodiments, inner surface 1210 of first shell 1219 can comprise a material (e.g., a ferrous metal) that is susceptible to inductive heating. In such embodiments, induction coil 1206 can be positioned so as to effect inductive heating of inner surface 1210 of first shell 1219.

In some embodiments, (not shown), coil 1206 can be present on or integrated into first component 1203 or even on or into first shell 1219. Coil 1206 can be present as a coiled, round wire, but can also be present as a coiled tape or flattened conductor. Coil 1206 can be disposed on or even integrated to surface 1207. As an example, first component 1203 can be present as a “can”, and coil 1206 can be present as on the “bottom” of the can. In some embodiments, first component 1203 does not include cup 1205; e.g., when first component is present as a can with a flat bottom portion that does not pouch or invaginate inward. Coil 1026 can also be disposed about first component 1203; in some embodiments, coil 1206 is not disposed within coil container 1218.

### Exemplary Embodiments

The following embodiments are illustrative only and do not necessarily limit the scope of the present disclosure or the appended claims.

Embodiment 1. An insulating module, comprising: a nonconducting first shell; a conducting first component, the first shell being disposed about the first component, (a) the first shell comprising a sealed evacuated insulating space, (b) the first shell and first component having a first sealed evacuated insulating space therebetween, the first component comprising a sealed evacuated insulating space, or any one or more of (a), (b), and (c); and a current carrier configured to give rise to inductive heating.

The first shell can be formed of a dielectric material, e.g., a ceramic. Crystalline and non-crystalline ceramics are considered suitable. The first shell and first component can be brazed together; suitable brazing techniques are known to those in the art and some exemplary techniques are presented in the documents cited elsewhere herein.

The first component can be, e.g., a tube, in some embodiments. The first component can also be solid, e.g., a cylinder. In some embodiments, the first shell and the first component are arranged coaxially, e.g., as concentric tubes. The first shell and the first component can have the same cross-sectional shape (e.g., circular, oblong, polygonal), but this is not a requirement. As one example, the first shell can be hexagonal in cross-section, and the first component can be circular in cross-section. It should also be understood that the first shell and the first component need not be arranged coaxially with one another.

The first component can comprise a dielectric material, e.g., a ceramic. This is not a requirement, however, as the first component can comprise a metal or other material that can be inductively heated. The first component can comprise a cermet material.

Embodiment 2. An insulating module, comprising: a conducting first shell; a non-conducting first component, the first shell being disposed about the first component, (a) the first shell comprising a sealed evacuated insulating space, (b) the first shell and first component having a first sealed evacuated insulating space therebetween, the first component comprising a sealed evacuated insulating space, or any one or more of (a), (b), and (c); and a current carrier configured to give rise to inductive heating.

The first shell can comprise a metal, e.g., stainless steel, an alloy, and the like. The first shell need not be completely metallic, however, and can comprise a cermet material in some embodiments.

The non-conducting first component can comprise a dielectric, e.g., a ceramic. Crystalline and non-crystalline ceramic materials can be used.

Embodiment 3. An insulating module, comprising: a non-conducting first shell; a non-conducting first component, the first shell being disposed about the first component, (a) the first shell comprising a sealed evacuated insulating space, (b) the first shell and first component having a first sealed evacuated insulating space therebetween, the first component comprising a sealed evacuated insulating space, or any one or more of (a), (b), and (c); and a current carrier configured to give rise to inductive heating. Without being bound to any particular theory, the current carrier can give rise to inductive heating of an additional component of the module, to inductive heating of a consumable engaged with the module, or any combination thereof.

Embodiment 4. The insulating module according to any one of Embodiments 1-3, further comprising a second sealed evacuated space disposed about the first shell, the second sealed evacuated space optionally being configured to contain heat evolved by the current carrier. As but one example, this can take the form of three concentric (inner, middle, and outer) tubes wherein there is a first sealed evacuated space between the inner and middle tubes and a second sealed evacuated space between the middle and outer tubes.

Embodiment 5. The insulating module according to any one of Embodiments 1-4, wherein the insulating module is configured to communicate a fluid within the first sealed evacuated insulating space. There can be one or more ports formed in the module so as to communicate the fluid into or out of the insulating space.

Embodiment 6. The insulating module according to any one of Embodiments 1-5, wherein the current carrier is disposed about the first shell, the current collector optionally contacting the first shell or optionally being integrated into the first shell. A barrier layer or coating can be used to prevent contact between the current collector and the first shell. The current collector can contact or even be integrated into the first shell, in some embodiments.

Embodiment 7. The insulating module according to any one of Embodiments 1-5, wherein the current carrier is disposed within the first sealed evacuated insulating space, the current collector optionally contacting one or both of the first shell and the first component or optionally being integrated into one or both of the first shell and the first component.

As one example, the current collector can be formed into the material of the first shell and/or first component. This can be accomplished by, e.g., molding the material of the first shell (e.g., a ceramic) around the material of the current collector. The current collector can be bonded to the first shell (and/or to the first component), but this is not a requirement.

In some embodiments, the current collector extends at least partially into or through the first shell and/or the first component in one or more locations. As an example, the first shell can include one or more apertures through which the current collector extends. It is not a requirement that the current collector pass through the first shell. As one example, the current collector can be wrapped around the first shell without extending through the material of the first shell.

Embodiment 8. The insulating module according to any one of Embodiments 1-5, wherein the current carrier is disposed within the first component, the current collector optionally contacting the first component or optionally being integrated into the first component. The current collector can be bonded to the first component. In some embodiments, the current collector extends at least partially into or through the first component at one or more locations.

As an example, the current collector can be wound as a coil within the lumen of the first component, as shown in exemplary FIG. 1C. It should be understood that the current collector need not extend through the material of the first component or the first shell, as the current collector could extend into the lumen of the first component without also extending through the material of the first component or of the first shell.

Embodiment 9. The insulating module according to any one of Embodiments 1-5, wherein the current carrier is configured to effect inductive heating of a working material disposed within the first component. As one such example, a working material can be disposed within the lumen of the first component.

The heating can be effected by giving rise to inductive heating directly within the working material itself. This can be applied in embodiments where the working material includes a component (e.g., a metal) that supports being inductively heated. This can also be effected where the current collector gives rise to heating of an element (e.g., element 114 in FIG. 1C) that in turn heats the working material. This can further be effected by inductive heating of at least a portion of the first shell and/or the first component.

Some suitable working materials useful in the disclosed modules include, e.g., metals, polymers, and the like. Plant-based materials (e.g., tobacco, herbal materials) are suitable working materials. Working materials that are flowable under heating and then resolidify under cooling are especially suitable, as such working materials are suited for additive manufacturing applications. A working material that is smokeable and/or partially vaporizes with heating is also suitable.

A working material can also be a liquid, semi-solid, or other non-solid form. In such embodiments, the working material can be comprised within a container, e.g., a capsule, cartridge, or other vessel. Such a vessel can include one or more pores, apertures, or passages configured to allow passage of smoke and/or vapor evolved from heating the working material. In some embodiments, the module can be configured to pierce a container (e.g., a capsule) so as to heat a material (e.g., a liquid) disposed therein. (The working material can, alternatively, be a consumable.) Working material can be shaped into a desired form, e.g., a cylinder, disc, plug, and the like. A working material can be shaped so as to engage with a locating feature (e.g., a ridge) that is configured to maintain the working material in location. It should be understood that modules according to the present disclosure can include one or more passages or spaces that allow a user to inhale one or more products evolved by heating a working material or consumable.

Embodiment 10. The insulating module according to any one of Embodiments 1-5, wherein the current carrier is configured to effect inductive heating of a working material disposed exterior to the first shell. The working material can be present as, e.g., a ring or coil disposed exterior to the first shell. There can be a further (e.g., second) shell disposed about such working material, and the further shell can define a further sealed, evacuated insulating space about the working material exterior to the first shell.

Embodiment 11. The insulating module of Embodiment 1, wherein the first shell comprises a ceramic.

Embodiment 12. The insulating module of Embodiment 2 or Embodiment 3, wherein the first component comprises a ceramic.

Embodiment 13. The insulating module according to any one of Embodiments 1-12, wherein one or both of the first shell and the first component comprises a shield that is at least partially opaque to a magnetic field. Such a shield can be, e.g., a magnetically-opaque material or even a Faraday cage. The shield can be passive or active; as examples, a solenoid or Helmholtz coil can be used.

Embodiment 14. The insulating module according to any one of Embodiments 1-13, wherein the first component defines a lumen therein. This can be, e.g., in an embodiment where the first component is tubular.

Embodiment 15. The insulating module of Embodiment 14, wherein the lumen of the inner shell defines a proximal end and a distal end. The lumen can have a constant cross-section along the length of the lumen, but can also have a variable cross-section.

Embodiment 16. The insulating module of Embodiment 15, wherein (a) the proximal end defines a cross-section, (b) the distal end defines a cross-section, and (c) the cross-section of the proximal end differs from the cross-section of the distal end.

The module can include a nozzle at one or both ends. Such a nozzle can be configured to dispense working material that has been heated and/or communicated through the module. The lumen can narrow (or flare) from one end to the other.

Embodiment 17. The insulating module according to any one of Embodiments 14-16, wherein the lumen of the first component is in fluid communication with a source of fluid. Such a fluid can be, e.g., a cleaning fluid, a flux, a cooling fluid, and the like.

Embodiment 18. The insulating module according to any one of Embodiments 1-17, wherein at least one of the first shell and the first component is essentially resistant to evolving inductive heat.

Embodiment 19. The insulating module according to any one of Embodiments 1-18, wherein the current carrier is characterized as helical. A current carrier can include, e.g., 1, 2, 3, 4, 5, 6, 7, 8, 9, 10, or more loops.

Embodiment 20. The insulating module according to any one of Embodiments 1-19, wherein the current carrier is in communication with a device configured to modulate a current communicated through the current carrier.

Such a device can include, e.g., a controllable current source configured to modulate the passage of current through the current carrier. Control of the current source can be manual, but it can also be automated. As one example, a module can be configured to heat working material to within a certain range of temperatures.

Embodiment 21. The insulating module according to any one of Embodiments 1-20, further comprising an amount of heat-sensitive working material disposed within the first component. Such a material can include, e.g., a metal, a polymer, and the like.

Embodiment 22. The insulating module according to any one of Embodiments 1-21, further comprising an amount of heat-sensitive working material disposed exterior to the first shell.

Embodiment 23. The insulating module according to any one of Embodiments 21-22, wherein the heat sensitive working material comprises a metal.

Embodiment 24. The insulating module of Embodiment 23, wherein the heat-sensitive working material is characterized as a wire.

Embodiment 25. The insulating module according to any one of Embodiments 21-24, wherein the heat-sensitive working material comprises a polymeric material.

Embodiment 26. The insulating module according to any one of Embodiments 22-25, wherein the heat-sensitive working material comprises a flux material.

Embodiment 27. The insulating module according to any one of Embodiments 1-26, further comprising an element configured to be inductively heated by the current carrier. Such an element can be, e.g., a wire, a ribbon, and the like. The element can comprise a metal, e.g., iron, nickel, cobalt, gadolinium, dysprosium, steel, and the like.

The element can be straight or linear, but can also be curved, bent, or otherwise nonlinear. In some embodiments, the element is inductively heated by the current carrier, with the heating of the element in turn heating a working material disposed within the insulating module. As one example, the element can be heated via induction heating, and the heated element can in turn heat the working material.

Modules according to the present disclosure can include one, two, three, or more elements. Similarly, a module according to the present disclosure can include one, two, or more current collectors. In this way, a module can be configured to effect inductive heating at different elements within the module. This in turn allows one to effect a heating profile within the module that varies with location and/or varies with time.

Embodiment 28. The insulating module of Embodiment 27, wherein the element is disposed within the first component.

Embodiment 29. The insulating module of Embodiment 27, wherein the element is disposed within the first sealed evacuated insulating space.

Embodiment 30. The insulating module of Embodiment 27, wherein the element is disposed exterior to the first shell.

Embodiment 31. The insulating module of claim 1, wherein the first component is characterized as a can or a tube in configuration, the first component having an interior surface that defines an interior volume of the first component. (FIG. 12A provides a non-limiting example of such an embodiment.)

Embodiment 32. The insulating module of claim 31, wherein the first shell is characterized as being tubular or a can in configuration.

Embodiment 33. The insulating module of claim 32, wherein the first component and the first shell are arranged coaxially with one another, about a first axis.

Embodiment 34. The insulating module of any one of claims 32-33, wherein the first component comprises a depression formed therein, the depression extending into the interior volume of the first component

Embodiment 35. The insulating module of claim 34, further comprising a coil container disposed about the current carrier, the coil container being disposed within the depression, and the current carrier being at least partially disposed within the coil container.

Embodiment 36. The insulating module of claim 35, wherein the coil container comprises an inner wall, an outer wall, and a sealed evacuated space formed therebetween.

Embodiment 37. The insulating module of claim 36, wherein a line extending radially outwardly and orthogonally from the first axis of the insulating module extends through the coil container, the depression, the first component, and the first shell.

An illustration of this can be found in FIG. 12C, which shows first axis 1250 and line 1252 extending radially outwardly and orthogonally from first axis 1250. As shown, line 1252 extends through coil container 1208, depression (cup 1205), first component 1203, and first shell 1219. In this way, the amount of induction is reduced as one moves outward along line 1252.

Embodiment 38. A method, comprising: operating the current carrier of an insulating module according to any one of Embodiments 1-37 so as to increase, by inductive heating, the temperature of a working material disposed within the inner shell of the insulating module.

Embodiment 39. The method of Embodiment 38, further comprising heating the working material so as to render the working material flowable.

Embodiment 40. The method according to any one of Embodiments 38-39, wherein the working material is a polymeric material, a metallic material, or any combination thereof. In some embodiments, the material can comprise a polymer having metallic portions disposed therein. Such a working material can then be inductively heated, as the metallic portions of the material will be sensitive to inductive heating and will in turn heat the material at large.

Embodiment 41. The method according to any one of Embodiments 38-40, wherein the working material is inductively heated by the current carrier.

Embodiment 42. The method according to any one of Embodiments 38-41, wherein the working material is heated so as to achieve a phase change of the material. Such a phase change can be from solid to liquid, but can also be from solid to gas/vapor, e.g., a volatilization.

Embodiment 43. The method according to any one of Embodiments 38-42, further comprising communicating the working material within the module so as to effect additive manufacture of a workpiece. Exemplary workpieces include, e.g., gears, housings, shells, tubes, wedges, lenses, straps, tabs, handles, and the like.

The communication of the can be effected mechanically, e.g., via a plunger or other mechanical element. The communication can also be effected by gravity or even by an applied pressure.

Embodiment 44. The method according to any one of Embodiments 38-43, further comprising communicating a cover fluid within the first sealed evacuated insulating space. Such a cover fluid can be a liquid or gas, and can be used to absorb heat present in the evacuated insulating space.

Embodiment 45. The method of Embodiment 44, wherein the fluid is introduced as a liquid and evaporated to gas form. In such an approach, the fluid is vaporized, thereby absorbing heat present in the evacuated insulating space.

Embodiment 46. An insulating module, comprising: a first shell that comprises a material susceptible to inductive heating, the first shell having a first sealed evacuated insulating space therein; and a current carrier configured to give rise to inductive heating of the material susceptible to inductive heating.

Such modules can include, e.g., a jig, collar, or other module configured to maintain in position a consumable that is inserted into the module. The module can be (e.g., via operation of the current carrier) operated to heat the consumable. Other features that can be present in the modules are provided in the other foregoing Embodiments.

Embodiment 47. An insulating module, comprising: a first shell, the first shell comprising a sealed evacuated insulating space; a first component, the first component being disposed within the first shell and the first component comprising a material that is susceptible to inductive heating, the first component being disposed within the first shell, the first component being configured to receive a consumable; an induction heating coil, the induction heating coil being configured to give rise to inductive heating of the first component.

Embodiment 48. The insulating module of Embodiment 47, wherein the first shell and the first component are cylindrical in configuration and are arranged coaxially with one another.

Embodiment 49. The insulating module of Embodiment 48, wherein the first component comprises a flat bottom portion, and wherein the induction heating coil is disposed on the flat bottom portion.

The disclosed modules are not limited in size, and can in fact be of any size that accords with the user's needs. As one example, a module according to the present disclosure can define a diameter of, e.g., from about 10 mm to about 20 mm, in some embodiments. An insulating module according to the present disclosure can be of virtually any length. As one example, an insulating module according to the present disclosure can have a length of from, e.g., about 20 mm to about 200 mm.

A module can also comprise a power source that is in electrical communication with the current collector. Such a source can be, e.g., a battery or other capacitor. Power sources can be rechargeable or disposable. A module can be portable or be stationary or be “plug-in” in configuration.

It should also be understood that modules according to the present disclosure can be useful in a broad range of applications. A non-limiting list of such applications includes, e.g., additive manufacturing, materials processing (e.g., phase change of materials, heat-based separation of one or more materials from a “base” material, and the like). A module according to the present disclosure can, in turn, be incorporated into a variety of systems.

One such system is an additive manufacturing system. In such a system, a module according to the present disclosure can be used to render flowable (via heating) a working material and then dispense that material. The dispensing can be controllable and in accordance with a pre-programmed schedule so as to additively form an article or workpiece. As but one example, a module according to the present disclosure can comprise a lumen formed within the first component 106. The lumen can in turn contain (or be in fluid communication with) a supply of heat-sensitive working material. The module can be actuated (e.g., via passing a current through the current collector so as to effect inductive heating of the working material) to place the working material into flowable condition. The flowable material can in turn be communicated out of the module (e.g., via gravity, via mechanical exertion) in a controllable fashion. As an example, a plunger, dam, or other spatially advancing element can be included to advance working material (whether in an initial state or a heated state) within or even out of a module according to the present disclosure.

A module according to the present disclosure can also be incorporated into a materials processing system, including reactive and non-reactive such systems. As one example, a module according to the present disclosure can be used to heat a base material so as to separate one or more components from the base working material. A base material can include a (first) component that can be liberated (e.g, becomes flowable) from the base material when the base material is heated at a certain temperature and a (second) component that is effectively unchanged when the base material is heated at that certain temperature. By effecting inductive heating of the base material within a module according to the present disclosure, a user can effect liberation of the first component from the base material.

In another exemplary materials processing system using the disclosed modules, a base working material can include one, two, ore more component that are individually heat-reactive or are heat-reactive with one another. By effecting inductive heating of the base material within a module according to the present disclosure, a user can effect the reaction of one or more of the components of the base working material. Such a reaction can give rise to one or more reaction products that can be collected by the user.

The disclosed modules can also be utilized in other heating applications, including consumer product applications. Modules according to the present disclosure can be incorporated into vaporizers, humidifiers, combustors, and the like.

1-49. (canceled)

50. An insulating module, comprising:
a first shell;
a first component,
the first shell being disposed about the first component,
(a) the first shell comprising a sealed evacuated insulating space, (b) the first shell and first component having a first sealed evacuated insulating space therebetween, (c) the first component comprising a sealed evacuated insulating space, or any one or more of (a), (b), and (c); and
a current carrier configured to give rise to inductive heating,
the current carrier being disposed within the first component or within the first sealed evacuated insulating space.

51. The insulating module of claim 50, wherein at least one of the first shell and the first component is non-conducting.

52. The insulating module of claim 50, further comprising a second sealed evacuated space disposed about the first shell, the second sealed evacuated space being configured to contain heat evolved by the current carrier.

53. The insulating module of claim 50, wherein the current carrier is disposed within the first component.

54. The insulating module of claim 50, wherein the current carrier contacts the first component.

55. The insulating module of claim 50, wherein the current carrier extends through an aperture formed in the first component.

56. The insulating module of claim 50, wherein at least one of the first shell and the first component comprises a ceramic.

57. The insulating module of claim 50, wherein the current carrier extends through an aperture formed in the first shell.

58. The insulating module of claim 50, wherein at least one of the first shell and the first component is essentially resistant to evolving inductive heat.

59. The insulating module of claim 50, further comprising a shield that is at least partially opaque to a magnetic field.

60. The insulating module of claim 59, wherein one or both of the first shell and the first component comprises the shield that is at least partially opaque to a magnetic field.

61. The insulating module of claim 50, wherein the current collector is operable at a frequency of from about 100 kHz to about 400 kHz.

62. The insulating module of claim 50, wherein the current collector is operable at a frequency of greater than about 400 kHz

63. The insulating module of claim 50, further comprising an element configured to be inductively heated by the current carrier.

64. The insulating module of claim 63, wherein the element is disposed within the first component.

65. A method, comprising:
operating the current carrier of an insulating module, the insulating module comprising:
a first shell;
a first component;
the first shell being disposed about the first component,
(a) the first shell comprising a sealed evacuated insulating space, (b) the first shell and first component having a first sealed evacuated insulating space therebetween, (c) the first component comprising a sealed evacuated insulating space, or any one or more of (a), (b), and (c); and
a current carrier configured to give rise to inductive heating,
the current carrier being disposed within the first component or within the first sealed evacuated insulating space; and
the operating being performed so as to increase, by inductive heating, the temperature of a working material disposed within the inner shell of the insulating module.

66. The method of claim 65, wherein the operating is performed so as to heat the working material without burning the working material.

67. An insulating module, comprising: a first shell, the first shell comprising a sealed evacuated insulating space; a first component, the first component being disposed within the first shell and the first component comprising a material that is sensitive to inductive heating, the first component being disposed within the first shell, the first component being configured to receive a consumable; an induction heating coil, the induction heating coil being configured to give rise to inductive heating of the first component.

68. The insulating module of claim 67, wherein the first component comprises a flat bottom portion.

69. The insulating module of claim 68, wherein the induction heating coil is disposed on the flat bottom portion.
